(19) United States
(12) Patent Application Publication
(10) Pub. No.: US 2016/0139571 A1
(43) Pub. Date: May 19, 2016

(54) SYSTEMS AND METHODS FOR MANAGINGING CHANGES TO MANUFACTURING PROCESSES

(71) Applicant: Caterpillar Inc., Peoria, IL (US)

(72) Inventors: Joseph R. HERRON, Farmington, IL (US); Yamin Z. Mohammed, Peoria, IL (US)

(73) Assignee: Caterpillar Inc., Peoria, IL (US)

(21) Appl. No.: 14/543,270

(22) Filed: Nov. 17, 2014

(51) Int. Cl. G05B 11/01; G06F 9/50

(52) U.S. Cl. CPC G05B 11/011; G06F 9/5011

(57) ABSTRACT

Systems and methods are disclosed for managing changes to manufacturing processes. According to certain embodiments, a first change is received for a first routing having a first effective date. A first change master associated with the first effective date is selected, and the first change is assigned to the first change master. A second change for the first routing is also received. The first change master is selected based on the first effective date, and the second change is applied to the first routing using the first change master.

### TECHNICAL FIELD

The present disclosure generally relates to systems and methods for managing changes to manufacturing processes and, more particularly, to systems and methods for managing changes to manufacturing processes by associating routing changes having the same effective date with a single change master.

### BACKGROUND

Manufacturing processes are subject to change based on a variety of factors, such as material defects, delayed supply of materials, material substitution, and process refinements. These changes can require updates to three different classes of data: material master (MM) data, bills of materials (BOM), and routings. Each of these classes of data may be updated independently of one another to accommodate changes to a manufacturing process. Moreover, each update may be associated with a different effective date. Accordingly, manufacturers require systems that efficiently manage these changes to keep their processes running smoothly and eliminate potential holdup.

Current systems for managing changes in a manufacturing process allow manufacturers separately to manage changes to MM data, BOMs, and routings using change masters. These systems, however, do not provide sufficient flexibility to manufacturers. For example, current systems assign routing changes to a change master based on routing and effective date. Thus, for any given effective date, there may be numerous change masters from which to pick for making updates to a routing. Moreover, the current techniques for allocating routing changes to change masters do not allow manufacturers to update the effective date of a routing, which is required, for example, when process changes or limited material availability hinders a manufacturer's ability meet an original effective date.

One technique for processing change requests to manage changes within an organization is described in U.S. Patent App. Pub. No. 2005/0080646 (“the '646 application”). The '646 application discloses that methods for managing change may comprise receiving, initiating, and validating change requests. According to the '646 application, a change request may be associated with a facility change, BOM change, or operations procedure change.

The techniques for managing change disclosed in the '646 application do not utilize change masters for purposes of implementing change requests. Thus, the '646 application does not describe how change requests may be assigned to change masters based on effective dates associated with the change requests. The '646 application further fails to describe how to implement changes to a routing that affect the effective date of the routing.

The present disclosure is directed to overcoming one or more of the problems set forth above and/or other problems in the art.

### SUMMARY OF THE INVENTION

In one aspect, the present disclosure is directed to a system for managing changes to manufacturing processes, including a memory that stores a set of instructions and at least one processor in communication with the memory and configured to execute the set of instructions to perform certain steps. The at least one processor is configured to receive a first change for a first routing having a first effective date. The at least one processor is further configured to select a first change master associated with the first effective date and assign the first change to the first change master. Moreover, the at least one processor is configured to receive a second change for the first routing. The at least one processor is configured to select the first change maser based on the first effective date and apply the second change to the first routing using the first change master.

In another aspect, the present disclosure is directed to a non-transitory computer-readable storage medium storing instructions for managing changes to manufacturing processes. The instructions cause the at least one processor to perform operations including receiving a first change for a first routing having a first effective date. The operations further include selecting a first change master associated with the first effective date and assigning the first change to the first change master. Further, the operations include receiving a second change for the first routing. The first change master is selected based on the first effective date, and the second change is applied to the first routing using the first change master.

### BRIEF DESCRIPTION OF THE DRAWINGS

FIG. 1 is an illustration of an exemplary system environment for managing changes to manufacturing processes;

FIG. 2 is a flow chart illustrating an exemplary disclosed method of managing changes to manufacturing processes; and

FIG. 3 is another flow chart illustrating another exemplary disclosed method of managing changes to manufacturing processes.

### DETAILED DESCRIPTION

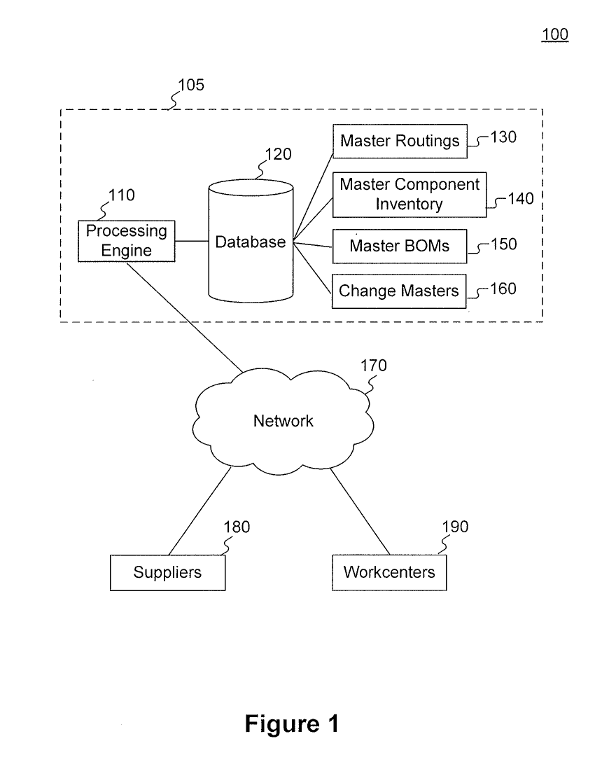

FIG. 1 depicts an exemplary system environment 100 for managing changes to manufacturing processes. As shown in FIG. 1, system environment 100 includes a number of components. It will be appreciated from this disclosure that the number and arrangement of these components is exemplary and provided for purposes of illustration. Other arrangements and numbers of components may be utilized without departing from the teachings and embodiments of the present disclosure.

As shown in FIG. 1, the exemplary system environment 100 includes a system 105. System 105 may include one or more server systems, databases, and/or computing systems configured to receive information from entities over a network and process and/or store the information. In one embodiment, system 105 may include a processing engine 110 and one or more databases 120, which are illustrated in a region bounded by a dashed line for system 105 in FIG. 1.

In one embodiment, system 105 may transmit and/or receive data to/from various other components of system environment 100, such as one or more suppliers 180 and workcenters 190. More specifically, system 105 may be configured to receive and store data transmitted over an electronic network 170 (e.g., comprising the Internet) from various data sources, including suppliers 180 and workcenters 190, process and/or store the received data, and transmit the processed data over the electronic network to consumers of the data, which may include suppliers 180 and workcenters 190, among others.

The various components of system environment 100 may include an assembly of hardware, software, and/or firmware, including a memory, a central processing unit (“CPU”), and/or a user interface. Memory may include any type of RAM or ROM embodied in a non-transitory computer-readable storage medium, such as magnetic storage including floppy disk, hard disk, or magnetic tape; semiconductor storage such as solid state disk (SSD) or flash memory; optical disc storage; magneto-optical disc storage; or any other type of physical memory on which information or data readable by at least one processor may be stored. Singular terms, such as “memory” and “computer-readable storage medium,” may additionally refer to multiple structures, such as a plurality of memories and/or computer-readable storage mediums. As referred to herein, a “memory” may comprise any type of computer-readable storage medium unless otherwise specified. A computer-readable storage medium may store instructions for execution by at least one processor, including instructions for causing the processor to perform steps or stages consistent with an embodiment herein. Additionally, one or more computer-readable storage mediums may be utilized in implementing a computer-implemented method. The term “computer-readable storage medium” should be understood to include tangible items and exclude carrier waves and transient signals. A CPU may include one or more processors for processing data according to a set of programmable instructions or software stored in the memory. The functions of each processor may be provided by a single dedicated processor or by a plurality of processors. Moreover, processors may include, without limitation, digital signal processor (DSP) hardware, or any other hardware capable of executing software. An optional user interface may include any type or combination of input/output devices, such as a display monitor, keyboard, and/or mouse.

As described above, system 105 may be configured to receive data over electronic network 170 and store the data. For example, system 105 may receive data over electronic network 170 from suppliers 180, which may supply components of one or more manufacturing processes. For example, system 105 may receive information from suppliers 180 regarding components available for purchase from supplier 180, including component identifier, cost, lead time (i.e., expected time it takes to ship the component calculated from order date), and inventory (i.e., number of components currently available).

System 105 may also receive data over electronic network 170 from workcenters 190. Workcenters 190 may represent physical or logical subdivisions within one or more manufacturing facilities that are responsible for one or more stages of an assembly process. System 105 may receive information from workcenters 190 regarding the assembly of one or more machines, such as necessary parts (e.g., bill of materials (BOM)), current inventory, demand, routings, labor information (e.g., days assemblers are available to work on an assembly), and workcenter responsibilities (e.g., a description of a workcenter's responsibilities with respect to an assembly).

In one embodiment, system 105 may store data received over electronic network 170 from suppliers 180, workcenters 190, and other sources in one or more databases 120. In an alternate embodiment, system 105 may store data received over electronic network 170 from suppliers 180, workcenters 190, and other sources in other memory associated with processing engine 110, including local memory of processing engine 110 or remote storage (e.g., a remote server in communication with processing engine 110 (not shown)). Database 120 may be any suitable combination of large scale data storage devices, which may optionally include any type or combination of slave databases, load balancers, dummy servers, firewalls, back-up databases, and/or any other desired database components. For example, processing engine 110 may receive information regarding the cost, inventory, and lead time for components from suppliers 180 and store this information in database 120. Processing engine 110 may receive information regarding the assembly process, such as necessary components, inventory, demand, routings, labor information, and workcenter responsibilities, from workcenters 190 and store this information in database 120. Processing engine 110 may further associate the information received from suppliers 180 and workcenters 190 with various tables or components of database 120, such as master routings 130, master component inventory 140, master BOMs 150, and change masters 160. For example, processing engine 110 may associate routing information received from workcenters 190 with master routings 130, component inventory with master component inventory 140, BOM information with master BOMs 150, and change requests with changes masters 160. Processing engine 110 may associate component supply information received from suppliers 180, such as component inventory (at the supplier), lead time, and cost, with master component inventory 140.

According to certain embodiments, database 120 stores master routings 130, master component inventory 140, master BOMB 150, and change masters 160. This information is used by system 105 to manage changes to manufacturing processes, according to one or more of the embodiments disclosed herein.

Master routings 130 may include one or more master routings associated with one or more models produced by a manufacturer. In one embodiment, each master routing includes a sequence of events associated with the assembly of a model. For example, a master routing for a Model 1 Tractor may include a sequence of events associated with the assembly of the Model 1 Tractor, such as assembly of the engine, assembly of the frame, etc. In one embodiment, each of the events in the sequence of events may be associated with a date in the assembly process. For example, the first event may be assigned to the start date (e.g., day 0) and later events in the assembly process may be assigned to later dates (e.g., days 1 through X).

In one embodiment, each routing in master routings 130 may have an effective date. The effective date for a routing may be a planned date for completion of the routing. For example, the effective date for a routing corresponding to a Model 1 Tractor may be the planned date for completion of the assembly of the Model 1 Tractor. Alternatively, the effective date for a routing may be a date at which the product associated with the routing is to be made available for shipment to customers.

In one embodiment, each routing in master routings 130 is associated with a bill of materials (BOM), which lists a plurality of components used to assemble a product associated with the routing. The BOM associated with each routing may be stored in master BOMB 150. Each of the components used to assemble the product associated with a routing, as reflected in the BOM for the product, may be included in master component inventory 140.

Master component inventory 140 may include an identification of each component used by a manufacturer to assemble any model of a product sold by the manufacturer. For example, if a manufacturer sells ten tractor models, master component inventory 140 would include an identification of each component used by the manufacturer to assemble any of the ten tractor models, regardless of whether the component is used in each model or only a subset of models. In one embodiment, master component inventory 140 includes an identification of each component involved in assembly of any model, as well as component cost, inventory (i.e., number of units in stock), description and/or modeling, lead time, planned lead-time offset value, and associated attachment information.

Master BOMs 150 may include bills of materials (BOMs) for each product manufactured by a manufacturer. Each BOM includes an inventory of each component used to assemble a product associated with the BOM. In addition to an identification of components used to build a product, a BOM may include other information about the components, such as the number of units of a component required for a routing and an identification of attachments associated with the component. An attachment is a subassembly of a routing that includes a plurality of individual components.

Change masters 160 are used to implement changes to manufacturing processes. A change master may be associated with MM data, a BOM, or a routing, and an effective date for the component, BOM, or routing. Moreover, MM data, BOMs, and routings that pertain to the same product may be implemented using different change masters. In one embodiment, changes to MM data, a BOM, or a routing associated with the same product must be made using different change masters.

In order to implement a change to MM data, a BOM, or a routing, a user accesses a change master associated with the component, BOM, or routing. If no change master exists for the MM data, BOM, or routing, the user creates a new change master and associates the change master with an effective date. Any changes made to the MM data, BOM, or routing are made using the change master corresponding to that MM data, BOM, or routing and effective date. For example, to change the inventory of components used to assemble a product associated with a given effective date, a user would access the change master associated with the BOM for the product and effective date and implement the change using that change master. The user may also access the change master associated with the routing for that product and make any changes to the routing necessitated by the BOM change using the change master associated with the routing. In one embodiment, all routings associated with the same effective date are associated with the same change master. Thus, changes to the routing for a Model 1 Tractor with an effective date of Jan. 1, 2015, and changes to the routing for a Model 2 Tractor with an effective date of Jan. 1, 2015, would be made using the same change master—the change master associated with all routings having an effective date of Jan. 1, 2015.

Some changes may alter that effective date for MM data, a BOM, or a routing. For example, if a supplier informs the manufacturer that the supplier is unable to provide a component used to assemble a product by a given date, the manufacturer may not be able to assemble the end product by the effective date for that product. Thus, a user may change the effective date of a BOM for the product using the change master associated with the BOM and original effective date. In one embodiment, the effective date for a routing may not be updated in a change master. Accordingly, to implement a change affecting the effective date of a routing, the user may unallocated the component from the routing using the change master associated with the original effective date and reallocate the component in the same routing using a different change master associated with the new effective date to align with the MM data and BOM change master effective date.

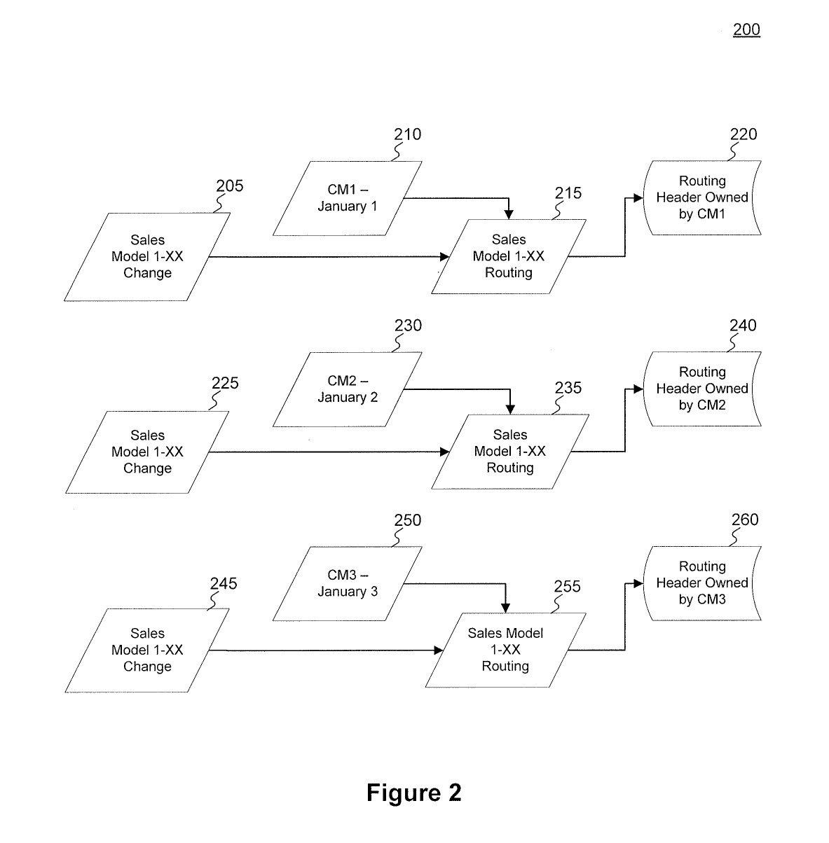

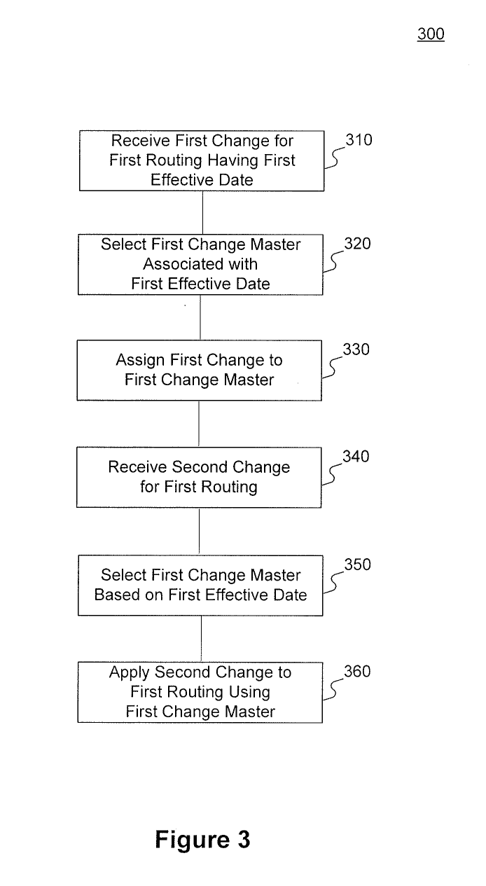

In accordance with certain embodiments, processing engine 110 receives a change request for a routing having an effective date from workcenters 190 or a user associated with processing engine 110 and processes the change request using a change master from among change masters 160. The change request may relate to a routing, component, or BOM included in master routings 130, master component inventory 140, or master BOMB 150, respectively. In one embodiment, processing engine 110 selects a change master having the first effective date from among change masters 160 and assigns the change to the selected change master. FIGS. 2 and 3, discussed below, provide further detail regarding techniques for managing changes to manufacturing processes.

### INDUSTRIAL APPLICABILITY

The disclosed systems and methods for managing changes to manufacturing processes may be utilized to implement changes to MM data, BOMB, and routings associated with the assembly of a product. In particular, the disclosed systems and methods enable users to implement a change using a change master associated with the MM data, BOM, or routing based on an effective date of the MM data, BOM, or routing. Moreover, the disclosed systems and methods allow users to update the effective date associated with MM data, a BOM, or a routing. Whereas prior methods did not allow a user to update the effective date associated with a routing using a change master, the disclosed system and methods enable the user to update the effective date associated with a routing by unallocating a component from the first routing using the first change master and reallocating the component to the first routing using a second change master associated with the updated effective date.

FIG. 2 depicts an exemplary flow of a process 200 for managing changes to manufacturing processes, in accordance with an embodiment of the present disclosure. The steps associated with this exemplary process may be performed by the components of FIG. 1. For example, the steps associated with the exemplary process of FIG. 2 may be performed by processing engine 110 and/or database 120 of system 105 illustrated in FIG. 1.

In step 205, processing engine 110 may receive a change to a routing for sales model 1-XX having an effective date of January 1. Sales model 1-XX may represent any sales model in the inventory of sales models manufactured by a manufacturer. In step 210, processing engine 110 accesses CM1, which is the change master associated with all routings having an effective date of January 1. Processing engine 110 accesses the routing associated with sales model 1-XX in step 215. As shown in step 220, the routing header for the routing associated with sales model 1-XX is owned by CM1. The change received at step 205, thus, may be implemented by CM1.

In step 225, processing engine 110 may receive a change to a routing for sales model 1-XX having an effective date of February 1. In step 230, processing engine 110 accesses CM2, which is the change master associated with all routings having an effective date of February 1. Processing engine 110 accesses the routing associated with sales model 1-XX in step 235. As shown in step 240, the routing header for the routing associated with sales model 1-XX is owned by CM2. The change received at step 225, thus, may be implemented by CM2.

In step 245, processing engine 110 may receive a change to a routing for sales model 1-XX having an effective date of March 1. In step 250, processing engine 110 accesses CM3, which is the change master associated with all routings having an effective date of March 1. Processing engine 110 accesses the routing associated with sales model 1-XX in step 255. As shown in step 260, the routing header for the routing associated with sales model 1-XX is owned by CM3. The change received at step 245, thus, may be implemented by CM3.

FIG. 3 depicts an exemplary flow of a process 300 for managing changes to manufacturing processes, in accordance with an embodiment of the present disclosure. The steps associated with this exemplary process may be performed by the components of FIG. 1. For example, the steps associated with the exemplary process of FIG. 3 may be performed by processing engine 110 and/or database 120 of system 105 illustrated in FIG. 1.

In step 310, a first change is received for a first routing having a first effective date. In one embodiment, the first effective date is a future date. A first change master associated with the first effective date is selected in step 320, and the first change is assigned to the first change master in step 330. In one embodiment, the first change master is associated with a plurality of routings. Further, each of the plurality of routings associated with the first change master may have the same effective date. Moreover, selecting a first change master associated with the first effective date may include creating a new change master associated with the first effective date and selecting the new change master.

In step 340, a second change is received for the first routing. The first change master is selected in step 350 based on the first effective date. In step 360, the second change is applied to the first routing using the first change master.

In one embodiment, a third change may be received for a second routing having the first effective date. In this embodiment, the first change master is selected based on the first effective date, and the third change is applied to the second routing using the first change master.

In one embodiment, the second change includes an updated effective date for the first routing. In this embodiment, applying the second change to the first routing includes unallocating a component from the first routing using the first change master and reallocating the component to the first routing using a second change master associated with the updated effective date.

In one embodiment, a fourth change is received for a component used in the first routing. This fourth change may be applied to the component using a change master that is different from the first change master. For example, a third change master may be selected based on an effective date of the component, and the fourth change may be applied to the component using the third change master. Further, a fifth change may be applied to the first routing, based on the fourth change to the component used in the first routing, using the first change master.

Several advantages over the prior art may be associated with the disclosed systems and methods for managing changes to manufacturing processes. Unlike the techniques described in the prior art, the disclosed techniques enable manufacturers to implement changes to routings associated with the same effective date using the same change master. Moreover, the disclosed techniques allow manufacturers to update the effective date for a routing by unallocating a component from the first routing using the first change master and reallocating the component to the first routing using a second change master associated with the updated effective date.

It will be apparent to those skilled in the art that various modifications and variations can be made to the disclosed systems and methods for managing changes to manufacturing processes. Other embodiments will be apparent to those skilled in the art from consideration of the specification and practice of the disclosed systems and methods for managing changes to manufacturing processes. It is intended that the specification and examples be considered as exemplary only, with a true scope being indicated by the following claims and their equivalents.

What is claimed is:

1. A system for managing changes to manufacturing processes, comprising:
a memory that stores a set of instructions; and
at least one processor in communication with the memory and configured to execute the set of instructions to:
receive a first change for a first routing having a first effective date;
select a first change master associated with the first effective date;
assign the first change to the first change master;
receive a second change for the first routing;
select the first change master based on the first effective date; and
apply the second change to the first routing using the first change master.

2. The system of claim 1, wherein the first effective date is a future date.

3. The system of claim 1, wherein the first change master is associated with a plurality of routings.

4. The system of claim 3, wherein each of the plurality of routings has the same effective date.

5. The system of claim 1, wherein the at least one processor is further configured to select a first change master associated with the first effective date by:
creating a new change master associated with the first effective date; and
selecting the new change master.

6. The system of claim 1, wherein the at least one processor is further configured to:
receive a third change for a second routing having the first effective date;
select the first change master based on the first effective date; and
apply the third change to the second routing using the first change master.

7. The system of claim 1, wherein:
the second change includes an updated effective date for the first routing; and
the at least one processor is configured to apply the second change to the first routing by:
unallocating a component from the first routing using the first change master; and
reallocating the component to the first routing using a second change master associated with the updated effective date.

8. The system of claim 1, wherein the at least one processor is further configured to:
receive a fourth change for a component used in the first routing,
wherein the fourth change is applied to the component using a change master that is different from the first change master.

9. The system of claim 1, wherein the at least one processor is further configured to:
receive a fourth change for a component used in the first routing;
select a third change master based on an effective date of the component; and
apply the fourth change to the component using the third change master.

10. The system of claim 9, wherein the at least one processor is further configured to apply a fifth change to the first routing, based on the fourth change to the component used in the first routing, using the first change master.

11. A non-transitory computer-readable storage medium storing instructions for managing changes to manufacturing processes, the instructions causing at least one processor to perform operations comprising:
receiving a first change for a first routing having a first effective date;
selecting a first change master associated with the first effective date;
assigning the first change to the first change master;
receiving a second change for the first routing;
selecting the first change master based on the first effective date; and
applying the second change to the first routing using the first change master.

12. The non-transitory computer-readable storage medium of claim 11, wherein the first effective date is a future date.

13. The non-transitory computer-readable storage medium of claim 11, wherein the first change master is associated with a plurality of routings.

14. The non-transitory computer-readable storage medium of claim 13, wherein each of the plurality of routings has the same effective date.

15. The non-transitory computer-readable storage medium of claim 11, wherein the instructions cause the at least one processor to select a first change master associated with the first effective date by:
creating a new change master associated with the first effective date; and
selecting the new change master.

16. The non-transitory computer-readable storage medium of claim 11, wherein the instructions further cause the at least one processor to:
receive a third change for a second routing having the first effective date;
select the first change master based on the first effective date; and
apply the third change to the second routing using the first change master.

17. The non-transitory computer-readable storage medium of claim 11, wherein:
the second change includes an updated effective date for the first routing; and
the instructions cause the at least one processor to apply the second change to the first routing by:
unallocating a component from the first routing using the first change master; and
reallocating the component to the first routing using a second change master associated with the updated effective date.

18. The non-transitory computer-readable storage medium of claim 11, wherein the instructions further cause the at least one processor to:
receive a fourth change for a component used in the first routing,
wherein the fourth change is applied to the component using a change master that is different from the first change master.

19. The non-transitory computer-readable storage medium of claim 11, wherein the instructions further cause the at least one processor to:
receive a fourth change for a component used in the first routing;
select a third change master based on an effective date of the component; and
apply the fourth change to the component using the third change master.

20. The non-transitory computer-readable storage medium of claim 19, wherein the instructions further cause the at least one processor to apply a fifth change to the first routing, based on the fourth change to the component used in the first routing, using the first change master.
